(19) United States
(12) Patent Application Publication
(10) Pub. No.: US 2015/0202974 A1
(43) Pub. Date: Jul. 23, 2015

(54) METHOD FOR OPERATING A CHARGING STATION

(71) Applicant: Audi AG, 85045 Ingolstadt (DE)

(72) Inventors: Gernot Rüb, Ingolstadt (DE); Alexander Kratzer, Pielenhofen (DE)

(73) Assignee: Audi AG, 85045 Ingolstadt (DE)

(21) Appl. No.: 14/416,232

(22) PCT Filed: Jul. 11, 2013
(86) PCT No.: PCT/EP2013/002043

§ 371 Date: Jan. 21, 2015

(30) Foreign Application Priority Data
Jul. 21, 2012 (DE) 10 2012 014 456.3

(51) Int. Cl. B60L 11/18

(52) U.S. Cl. CPC B60L 11/1816; B60L 11/1824

(57) ABSTRACT

In a method for operating a charging station which is designed for electrically charging an electrically powered vehicle, the vehicle is coupled to the charging station for charging, wherein a time for the coupling of the vehicle to the charging station is documented separately at least by the vehicle and the charging station.

The invention relates to a method for operating a charging station according to the preamble of the dependent claim 1.

For operating electric vehicles it is necessary that it been snapped of charging stations similar to a network of fueling stations for vehicles with internal combustion engines is available. A so-called charging infrastructure for electric vehicles is therefore an essential factor for the acceptance and with this the success of electric vehicles. At a number of about 1 million electric vehicles estimated for the year 2020 on German streets, a corresponding number of charging stations has to be available. With the charging stations available today the infrastructure costs generated hereby will be significant, which is why currently no comprehensive charging station infrastructure can be expected.

The known systems are not convenient because a customer first has to identify himself at the charging station with an identification key in the form of a token (for example RFID) or with a credit card in order to be authorized for the charging process. Such an identification is necessary in order to assign the delivered energy to the customer and also to be billed to the customer. The billing occurs directly after the charging process on a device provided therefore. Collective invoices are not possible with such systems.

This is intended to be solved with a refinement of a charging station. Here the identification and also the authorization of the customer are intended to occur by via a charging interface (for example a cable) or as the case may be via near-field communication. Hereby, after transmitting identification-relevant data via the charging cable LK, the eligibility for charging on a central charging station—a so-called clearing site—is queried and in the case of an affirmative answer the charging is authorized. With the charging the billing-relevant data are transmitted to this clearing site so that the data of different charging stations can be centrally stored for a customer. Via this the customer can obtain a collective invoice.

These systems have the disadvantage that no uniform communication media are available because the vehicles are not only charged via charging cables but also via contactless methods. Thus no direct data connection between the vehicle and the charging station exists in the case of an inductive charging and also in the case of direct current fast charging. These charging stations therefore have to be excluded from the system.

In addition the known systems also have the disadvantage that a vehicle can only be assigned to a charging station with great effort. This assignment occurs via a positional signal received via GPS, which is transmitted to a central processor. This processor then queries possible charging stations installed in the region of the positional signal, because a GPS signal only determines an approximate location. The query relates to information whether the vehicle parks at a charging station or not, based on which the vehicle is to be assigned to a particular charging station.

In addition providing effective coding and decoding hardware in the vehicle in this type of charging communication involves costs for manufacturers.

It is therefore an object of the present invention to provide a simplified and secure system of the invoicing system, which is also more cost-effective than the known systems.

A method for solving the object of the invention has the features of independent claim 1. Accordingly a method is proposed for operating a charging station which is configured for the electric charging of an electrically driven vehicle, wherein the vehicle is coupled to the charging station for charging, wherein the vehicle detects and records at least a first coupling time point of the vehicle to the charging station and the charging station detects and records at least a second coupling time point of the vehicle to the charging station. As a result of the recordation of the time point, a vehicle can be assigned to a charging station with sufficient accuracy. With this the determination of the exact geographical position of the vehicle is no longer necessary, as known from the state-of-the-art because the GPS signal has an error of several meters.

According to a preferred embodiment of the method, it can be provided that the vehicle generates a first data set which beside the coupling time point also contains an identification and in particular a geographical position of the vehicle. With coupling time point and the identification of the vehicle, the vehicle can clearly be identified and associated with the charging station with sufficient accuracy. The additional information of the geographical position of the vehicle can hereby be provided as a verification of the data, which are obtained anyway.

It can further be provided that the charging station generates a second data set, which beside the coupling time point also contains an identification and in particular the geographical position of the charging station. With this second data set the same advantages can be achieved as set forth in the preceding paragraph with regard to the vehicle. Preferably both units can be associated to each other by the two data sets.

According to a preferred embodiment, the data sets of the vehicle and of the charging station can be transmitted to a central processor wherein in particular the central processor authorizes a charging process when the first and the second time point substantially correspond to each other. The charging process is only authorized when data are present that enable an invoicing of the charging process, wherein for this purpose the coupling time points of the vehicle and that of the charging station, which are transmitted separate from each other, are determinative. For this purpose data for the charging station and of the vehicle are stored in a database of the central processor.

Contrariwise it can be provided that the charging process is not authorized when the identification of the vehicle is not stored in the central processor, no two substantially corresponding coupling time points are present at essentially same geographical position of the vehicle and the charging station, and/or no substantially corresponding two geographical positions of the vehicle and the charging station are present at substantially corresponding coupling time points. Because the association of the charging station with the vehicle occurs essentially via the data sets or the coupling time points, the charging process can be denied when the data sets do not temporally match.

It can further be provided that an end time point of the charging process is documented by the charging station and/or the vehicle and is transmitted to the central processor. For the accurate invoicing of the obtained energy it is sufficient when only the charging station documents the end time point. For verification purposes however the vehicle can also transmit these data to the central processor.

In the following a preferred exemplary embodiment is explained in more detail by way of a drawing. It is shown in:

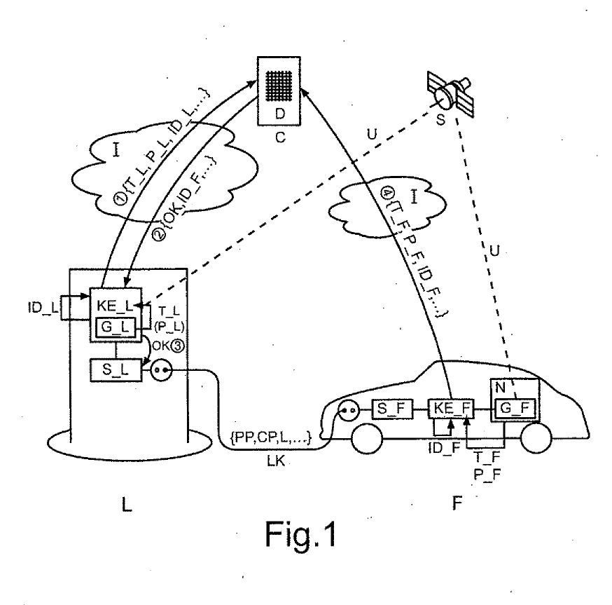

FIG. 1 a schematic drawing of a charging station with coupled vehicle and transmission pathways of the documented information;

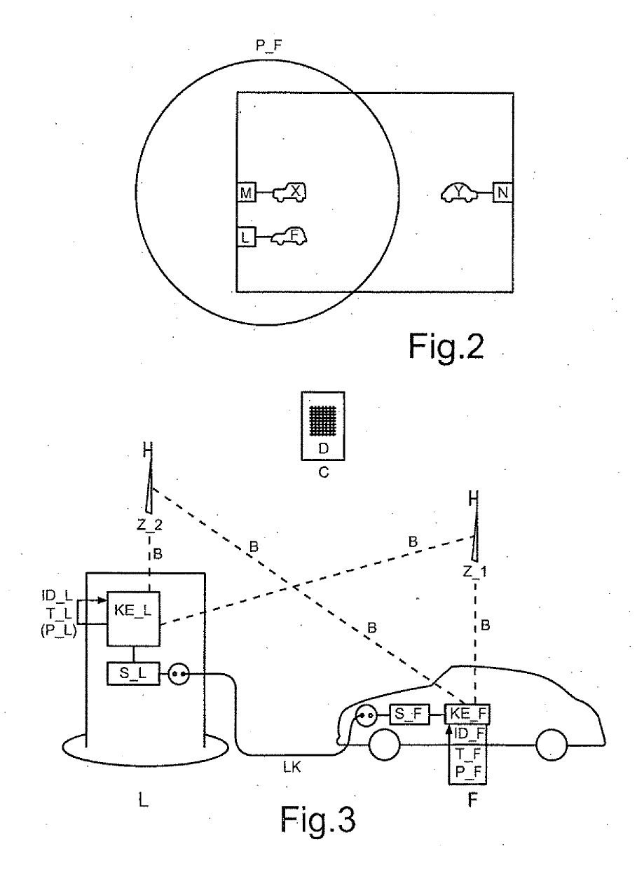

FIG. 2 an exemplary presentation of multiple vehicles with similar geographical position; and

FIG. 3 a schematic representation of a localization via local networks by means of triangulation.

FIGS. 1 to 3 exemplary illustrate the method described in the following. In this method at least one electric vehicle F or a vehicle which is at least partially electrically driven—in the following both terms are used synonymously—is to be recharged with electric energy at charging station L which is provided for this purpose. The charging station L generally means a charging infrastructure and is meant to include any possibility of charging an electric vehicle F.

For the charging the electric vehicle F and the charging station L are brought together, wherein preferably the vehicle F is driven to the station L. The actual charging process is only marginally relevant for the method, which is why the different types of charging do not have to be described. It is noted however that the described method works with all types of charging. This includes beside a cable-bound charging also a contactless charging such as inductive charging. It is common that for invoicing reasons the charging process is documented during the charging of the batteries of the vehicle F so that the delivered energy can be associated to an owner of the vehicle F. For this purpose, in order to enable initiation of the charging process, a coupling of the vehicle F to the charging station L is detected by both units F or L.

For this reason the vehicle F has a plug control unit S-F, which is able to communicate with a corresponding plug control unit S-L. The plug control unit S-F does not have to be assigned a physical plug. In the case of an inductive charging the plug control unit S-F can also be an equivalent device. The plug control units S-F and S-L register the coupling of vehicle F and charging station L.

Both the vehicle L and the charging station L additionally have a communication unit KE-F or KE-L, which are respectively connected with the Internet via a mobile wireless network. Via this network data can be transmitted to a central processor C, which will be explained in more detail below. The communication unit KE-F of the vehicle F is connected with the plug control unit S-F and a navigation system N via a vehicle bus B-F. The navigation system N has a GPS module G-F, which enables determining a substantially accurate position of the vehicle F by means of a satellite S. On the side of the charging station L the communication unit KE-L is also connected with the plug control unit S-L via a data bus B-L and can communicate with the Internet via the mobile wireless network. As an alternative the communication unit KE-L of the charging station L can also be connected with the Internet via cable so that access to the central processor is possible in two different ways. Usually a position of the charging station L is known and stored in the communication unit KE-L, however, a GPS module G-L can also be integrated in the station L via which the position of the charging station L can be queried. Further the position of the vehicle F and the charging station L can also be queried via a so-called triangulation B within a GSM network or W-LAN network. Preferably, in cities superimposing multiple GSM stations enables a sufficiently accurate triangulation B of the vehicle F and the charging station L via a signal strength. Also a transmission range of the GSM station may also be already sufficient to determine the position of the vehicle F and the charging station L. The same also applies to the position determination means of a WLAN network.

When coupling the vehicle F to the charging station L this process is registered by both plug-control units S-F and S-L and is transmitted to the respective communication units KE-F or KE-L. The coupling can be performed manually by a driver of the vehicle F by connecting a charging cable LK. Hereby the insertion of the plug into a corresponding outlet preferably triggers the registering of the coupling. The coupling however may also occur in that the vehicle F drives into a substantially predetermined parking position at the charging station L. In this parking position both systems, in case of an inductive charging can then for example register that a respective other system is present in direct proximity.

In the following the method is described by way of the first coupling example. During coupling the connection is detected respectively by the plug control units S-F and S-L via a lead (Plug-Present (PP)) provided therefor and the exact time point is recorded. The time point has to be determined with sufficient accuracy preferably within the range of a second, preferably a tenth of a second and particularly preferably within a millisecond range. The time point can be determined via the GPS module G-F and G-L because a GPS signal also always contains a time signal. As an alternative the time can also be determined via the mobile wireless network because the GSM network also transmits a time signal. As a further possibility it can be provided that the time is determined via the DCF-77 standard, which means that a wireless clock is integrated in the vehicle F and/or the charging station L. The time point can further be determined via the Internet, i.e., via the network-time-protocol (NTP).

The time point documented by the coupling process is transmitted from the plug control units S-F and S-L to the respective communication units KE-F and KE-L which in turn transmit the exact time point independent of each other to the central processor C. The transmission occurs via the Internet or also as SMS in the GSM network. For this purpose the charging station L can either transmit information or data, designated I in the drawing, to the central processor C via the GSM network, or via the fixedly installed cable; in case of the vehicle the transmission is accomplished wirelessly.

The central processor C represents an invoicing site, which collects information regarding the individual charging processes and forwards the gathered data, in particular the used energy, to a electricity company of which the owner of the vehicle F is a customer. The electricity company then correspondingly issues an invoice to the driver. Such an invoicing site is also known as clearing-site because data are centrally gathered and forwarded.

With the time signal also an identification ID-F of the vehicle F and preferably also of the charging station L (ID-L) is transmitted to the central processor C. with these items of information I which are also referred to a s time stamp, the central processor C analyses whether the units ID-F and ID-L are registered in a database of the central processor C. it is further analyzed whether the vehicle F has a proper status regarding the charging station L, i.e., whether the vehicle F can charge energy at the charging station L. the time stamp is essentially a data set which beside the coupling time point T-F, T-L also contains other items of information I explained below.

The accurate determination of the time enables association of the two data sets with each other in the central processor C even when the vehicle F and the charging station L have transmitted the respective data sets to the central processor independent of each other. This is so because there it can be assumed with sufficient accuracy that when determining the time within the millisecond range, not more than two time stamps are inputted into the central processor C. It is also not important when the data sets reach the central processor. Via the data sets the vehicle F and the charging station L can be associated with each other.

This association can further be verified according to a further exemplary embodiment, in that together with the documentation of the time point and generating the time stamp also the position P-F or P-L of the vehicle F and/or the charging station L is determined and transmitted to the central processor C. this facilitates the association of vehicle F and charging station L, i.e., via identification ID-F, ID-L, time point T-F, T-L and position P-F, P-L. the central processor c filters via the position P-F and P-L with a tolerance delta −P all transmissions to the central processor C with a time of the vehicle F or other vehicles x, which is also shown in FIG. 2. This allows significantly limiting the number of vehicles X when actually more than two data sets with identical time are generated.

The delta-P is necessary because the GPS signal does not allow a determination of the position, which is accurate within the range of a meter. Therefore the same position may be given for different vehicles when multiple charging stations L are present at the same location.

When the clearing site C can associate two data sets—from a vehicle F and a charging station L—to each other and can also determine that the remaining conditions are satisfied, the clearing station C transmits a release signal OK to the communication unit KE-L of the charging station. It essentially contains the release for the vehicle F and can optionally also contain its identification ID-F. In case of a verification of the data set via the position P-F and P-L, the release can also occur when the time of the coupling of the vehicle F and the charging station L itself has a delta-T, which should be selected very low however.

When no association is possible the clearing site transmits a negative signal NOK to the charging station L not to start the charging process.

With transmission of the release signal OK to the communication unit KE-L, the KE-L transmits the release to the plug control unit S-L so that the vehicle F can be charged. During the charging the vehicle remains able to communicate.

After the charging process is complete or when the vehicle F interrupts the charging, the charging station L transmits the energy taken up by the vehicle F to the central processor C via its communication unit KE-L so that the clearing site can either calculate the generated incurred costs itself or forward the data to an energy supplier or energy concern of the vehicle owner.

As a further verification the vehicle F and/or the charging station L preferably again transmits the identification ID-F, ID-L, the position P-F, P-L and the time point of the coupling and de-coupling to the central processor C.

In the case of reception problems of the position signals or time signals, which have been received can be continued via the method of the clock synchronization, which also allows a sufficiently exact determination of the time and the position. It is always possible that due to signal interferences or other problems the exact determination of the time or geographical position is not possible so that the time and/or position signals that were received at an earlier time point can be continued with the clock synchronization. From these continued signals an accurate data set can thus be generated. The delta-T, which may arise due to this is taken into account by the central processor during the authorization.

The method can also be configured so that all charging relevant data, in particular the start, the end time point and the amount of the taken up energy are recorded by the communication unit KE-F of the vehicle F and transmitted to the central processor C, wherein a corresponding measuring unit is present in the vehicle F for this purpose.

The afore described method an easily be implemented because the required infrastructure is already present in electrically driven vehicles F and charging stations L and thus no new expensive technology has to be installed. With the method preferably the currently existing problems can be overcome in that a user of a charging station invoices the charged energy via its electricity company. Hereby it is determined during the authorization whether the customer or his vehicle and the electricity company are present in a database D of the central processor C in order to authorized the current flow between the charging station L and the vehicle F. the central processor transmits after completion of the charging process the determined data together with the amount of the charged energy to the electricity company responsible for the customer, which electricity company in turn invoices its customer the retrieved energy with its specific rate and ensures that the amount of the retrieved energy is made available to a electricity network to which the charging station L is connected. In this way each customer can be supplied with current according to his individual demands because an electricity company on one hand can operate charging stations with electricity exclusively derived from renewable energies and on the other hand feed the corresponding electricity into a large integrated network. Other electricity company can feed electricity gained from coal-powered power plant into the integrated network.

For limiting the number of charging stations L, which are associated to a central processor C, multiple central processors can also be provided for the method. Each central processor is assigned a defined number of charging stations L, which are preferably provided in a geographical region. These regions can be selected to be of different size and can for example correspond to state borders. Each central processor would then be responsible for a state or only a part of a state.

What is claimed is:

1.-6. (canceled)

7. A method for operating a charging station which is configured for electrically charging an electrically driven vehicle, comprising:
coupling the vehicle to the charging station;
detecting and documenting by the vehicle at least a first coupling time point of the vehicle to the charging station; and
detecting and documenting by the charging station at least a second coupling time point of the vehicle to the charging station.

8. The method according of claim 1, further comprising generating by the vehicle a first data set, including the coupling time point and an identification of the vehicle.

9. The method according of claim 8, wherein the identification is a geographical position of the vehicle.

10. The method according to claim 8, further comprising generating by the charging station a second data set, which includes the coupling time point further and an identification of the coupling station.

11. The method according to claim 10, wherein the identification of the charging station is a geographical position of the charging station.

12. The method of claim 10, further comprising transmitting the first and second data sets to a central processor, and authorizing a charging process authorized by the central processor when the first and second coupling time points correspond to each other.

13. The method of claim 2, further comprising denying the charging process in the event of at least one of
a) the identification of the vehicles not stored in the central processor,
b) no two essentially corresponding coupling time points are present at essentially same geographical position of the vehicle and the charging station and
c) no essentially corresponding geographical positions of the vehicle and the charging station are present at essentially corresponding coupling time points.

14. The method of claim 12, further comprising documenting an end time point of the charging process by the charging station and/or the vehicle and communicating the end point to the central processor.
